(19) United States
(12) Patent Application Publication
(10) Pub. No.: US 2014/0011493 A1
(43) Pub. Date: Jan. 9, 2014

(54) BASE STATION DEVICE, TERMINAL DEVICE, COMMUNICATION SYSTEM, AND COMMUNICATION METHOD

(71) Applicants: Shinpei Toh, Osaka-shi (JP); Kozue Hirata, Osaka-shi (JP)

(72) Inventors: Shinpei Toh, Osaka-shi (JP); Kozue Hirata, Osaka-shi (JP)

(73) Assignee: SHARP KABUSHIKI KAISHA, Osaka-shi, Osaka (JP)

(21) Appl. No.: 14/006,975

(22) PCT Filed: Feb. 3, 2012
(86) PCT No.: PCT/JP2012/052472

§ 371 Date: Sep. 24, 2013

(30) Foreign Application Priority Data
Mar. 29, 2011 (JP) 2011-073477

(51) Int. Cl. H04W 16/14; H04W 24/10

(52) U.S. Cl. CPC H04W 16/14; H04W 24/10
USPC 455/422.1

(57) ABSTRACT

There is provided a first base station device in a communication system in which, within a wide coverage area of a first cell, at least one second cell having a coverage area narrower than the coverage area of the first cell is present, the first base station device controlling the first cell. The first base station device supplies information concerning a transmission weight to a second base station device which controls the second cell, the transmission weight being used by a terminal device which transmits a data signal to the second base station device. With this configuration, in a system in which a plurality of cells with a small zone radius are present in a cell with a large zone radius, it is possible to determine, with a small amount of calculations, transmission and reception weights that can eliminate interference received by the cell with a large zone radius from the plurality of cells with a small zone radius.

### TECHNICAL FIELD

The present invention relates to a base station device, a terminal device, a communication system, and a communication method.

### BACKGROUND ART

In a system constituted by a plurality of cells having different zone radii, when communication is performed by using the same frequency band, inter-cell interference occurring between these cells having different zone radii is a serious problem. For example, in a system in which picocells and femtocells with a small radius are present in a macrocell with a large radius and having a large coverage area, when, for example, a picocell base station (PeNB: Pico eNodeB) and a femtocell base station (HeNB: Home eNodeB) respectively receive signals from terminals (a picocell terminal and a femtocell terminal) included in the picocell base station and the femtocell base station, these signals cause interference for a macrocell base station (MeNB: Macro eNodeB) which receives a signal from a macrocell terminal. In particular, if many picocells and femtocells are present in a macrocell, reception characteristics of MeNB may considerably deteriorate.

To address such a problem, the following method has been proposed (see the following NPL 1). MeNB notifies each HeNB of an upper tolerance value of interference to be received from one femtocell by the MeNB, and each HeNB controls transmission power of a femtocell included in the associated HeNB so that the interference received by the MeNB does not exceed the specified upper tolerance value. NPL 1 describes that, by the use of such transmission power control, even in a situation in which the number of femtocells is increased or decreased by switching ON/OFF a power source, the interference received from femtocell terminals by MeNB can be maintained within a constant, small value, and also, a certain level of throughput can be achieved in femtocells.

Additionally, as an effective method for suppressing interference in a multicell system using the same frequency band, Interference Alignment (hereinafter referred to as “IA”) has been proposed (see the following NPL 2). IA is the following technology for performing transmission and reception by using transmission weights and reception weights. Each transmission device and each reception device calculate a transmission weight and a reception weight in cooperation with each other so that the directions (vectors) of equivalent propagation channels of interference signals transmitted from a plurality of transmission devices (for example, base stations), which are interference sources, will be orthogonal to a reception weight by which a received signal is multiplied in a reception device (for example, a terminal). By performing such control, even in a case in which interference signals more than the number (degrees of freedom) of interference signals which can be removed by the reception device are transmitted from an adjacent cell, such interference signals can be removed, thereby making it possible to extract a desired signal from a received signal with high precision. In this technology, control is performed by way of example so that interference signals transmitted from a plurality of base stations can be removed by a terminal of each cell. Conversely, control may be performed so that interference signals transmitted from a plurality of terminals positioned within a plurality of cells can be removed by a base station of each cell. Additionally, such a technology may be used, in a system in which a plurality of picocells and femtocells are present in a macrocell, for suppressing interference occurring between these cells having difference zone radii.

### CITATION LIST

### Non Patent Literature

NPL 1: “Network Assisted Uplink Transmission Power Control Method for Home Base Station in LTE-Advanced”, The Institute of Electronics, Information and Communication Engineers (IEICE), Technical Report of IEICE, RCS2009-153, November 2009.
NPL 2: “Approaching the Capacity of Wireless Networks through Distributed Interference Alignment”, IEEE GLOBECOM 2008.

### SUMMARY OF INVENTION

### Technical Problem

In the technology proposed in the above-described NPL 1, control is performed for setting transmission power of cells (picocells and femtocells) with a small zone radius to a small level so that the interference which may influence a cell (macrocell) with a large zone radius can be maintained within a constant value. In this case, in cells with a small zone radius, transmission may not be always performed with sufficient transmission power. Accordingly, reception characteristics of these cells deteriorate, and thus, the throughput of the entire system is decreased.

In the case of the use of the technology proposed in the above-described NPL 2, in a system in which the number of cells (a total number of a desired cell and all cells, which may be interference sources, for example, a total number of macrocells, picocells, and femtocells) to which IA is applied is three or more, it is necessary to calculate transmission weights and reception weights through repeated operations in order to eliminate the interference in a reception device. As a result, the amount of calculations is considerably increased.

Additionally, as measures to prevent the occurrence of interference between cells having different zone radii, there is a method for setting the frequency and the time used in a cell with a larger zone radius to be different from those used in a cell with a smaller zone radius. In this case, however, the frequency use efficiency is considerably reduced.

It is an object of the present invention to determine, with a small amount of calculations, in a system in which a plurality of cells with a small zone radius are present in a cell with a large zone radius, transmission and reception weights that can eliminate the interference received by the cell with a large zone radius from the plurality of cells with a small zone radius.

### Solution to Problem

According to one aspect of the present invention, there is provided a first base station device in a communication system in which, within a wide coverage area of a first cell, at least one second cell having a coverage area narrower than the coverage area of the first cell is present, the first base station device controlling the first cell. The first base station device supplies information concerning a transmission weight to a second base station device which controls the second cell, the transmission weight being used by a terminal device which transmits a data signal to the second base station device.

The first base station device determines a transmission weight to be used in the second cell so that an equivalent propagation channel of an interference signal reaching the first cell will be orthogonal to a reception weight to be used in the first cell, and supplies information concerning the transmission weight to each second base station device. By multiplying a received signal by the reception weight, it is possible to eliminate an interference signal transmitted from the second cell, thereby enabling both the first cell and the second cell to obtain good characteristics.

The first base station device may supply information concerning a plurality of transmission weights to the second base station device. The first base station device may include a propagation channel estimating unit that estimates a propagation channel between the first base station device and each terminal device on the basis of a received propagation channel estimating signal, and a transmission/reception weight calculator that calculates, on the basis of a propagation channel between the first base station device and each terminal device estimated by the propagation channel estimating unit, a reception weight to be used by the first base station device itself, a transmission weight to be used by a terminal device positioned in the first cell, and a transmission weight to be used by a terminal device positioned in the second cell. The first base station device may also include a reception weight multiplier that determines a desired signal on the basis of processing for multiplying a received signal by the reception weight used by the first base station device itself, among the transmission and reception weights calculated by the transmission/reception weight calculator. The reception weight multiplier may calculate a transmission weight to be used by each terminal device positioned in the second cell in order to perform control so that an equivalent propagation channel of an interference signal transmitted from the terminal device positioned in the second cell will be orthogonal to the reception weight.

The present invention also provides a second base station device in a communication system in which, within a wide coverage area of a first cell, at least one second cell having a coverage area narrower than the coverage area of the first cell is present, the second base station device controlling the second cell. The second base station device obtains information concerning a transmission weight from a first base station device which controls the first cell, the transmission weight being used by a terminal device which transmits a data signal to the second base station device, and the second base station device supplies the obtained information concerning the transmission weight to the terminal device.

The present invention also provides a terminal device in a communication system in which, within a wide coverage area of a first cell, at least one second cell having a coverage area narrower than the coverage area of the first cell is present, the terminal device transmitting a data signal to a second base station device which controls the second cell. The terminal device transmits a data signal to the second base station device by using a transmission weight reported from a first base station device which controls the first cell.

The present invention also provides a communication system in which, within a wide coverage area of a first cell, at least one second cell having a coverage area narrower than the coverage area of the first cell is present. Information concerning a transmission weight to be used by a terminal device which transmits a data signal to a second base station device which controls the second cell is supplied from a first base station device which controls the first cell to the second base station device.

According to another aspect of the present invention, there is provided a communication method for use in a first base station device in a communication system in which, within a wide coverage area of a first cell, at least one second cell having a coverage area narrower than the coverage area of the first cell is present, the first base station device controlling the first cell. The communication method includes a step of supplying, to a second base station device which controls the second cell, information concerning a transmission weight to be used by a terminal device which transmits a data signal to the second base station device.

The present invention may be a program for causing a computer to execute the above-described communication method, or may be a computer-readable recording medium recording the program thereon.

This application incorporates herein the contents of the specification and/or the drawings of Japanese Patent Application No. 2011-073477, which is a basis of priority of this application.

### Advantageous Effects of Invention

According to the present invention, it is possible to determine, with a small amount of calculations, in a system in which a plurality of cells with a small zone radius (cells having a narrow coverage area) are present in a cell with a large zone radius (a cell having a wide coverage area), transmission and reception weights that can eliminate the interference received by the cell with a large zone radius from the plurality of cells with a small zone radius. Additionally, since transmission power of the cells with a small radius is not reduced, reception characteristics of such cells do not deteriorate. Moreover, simultaneous communication using the same resource performed by all cells can be implemented, thereby making it possible to construct a system exhibiting excellent frequency use efficiency.

### BRIEF DESCRIPTION OF DRAWINGS

FIG. 1 illustrates an example of the configuration of a system used in an embodiment of the present invention.

FIG. 2 is a functional block diagram illustrating an example of the configuration of a MeNB device according to a first embodiment of the present invention.

FIG. 3 is a functional block diagram illustrating an example of the configuration of a PeNB device according to the first embodiment of the present invention.

FIG. 4 is a functional block diagram illustrating an example of the configuration of a terminal device according to the first embodiment of the present invention.

FIG. 5 is a functional block diagram illustrating an example of the configuration of a PeNB device according to a second embodiment of the present invention.

FIG. 6 illustrates, by taking a wireless LAN as an example, a situation in which a first terminal transmits a signal to an AP, a second terminal transmits a signal to a third terminal, and an AP transmits a signal to the third terminal.

### DESCRIPTION OF EMBODIMENTS

A communication technology according to an embodiment of the present invention will be described below with reference to the drawings.

### First Embodiment

There is a system in which a macrocell having a wide coverage area is present and a plurality of picocells having a narrow coverage area is present within the macrocell, and one terminal is included in each cell. In a first embodiment of the present invention, a description will be given of the generation of transmission and reception weights and the transmission and reception of signals using these transmission and reception weights in the above-described system. The transmission and reception weights are used for making it easy for a base station of the macrocell to eliminate interference, mainly the interference received by the base station of the macrocell from the terminals within the picocells, by the multiplication of a linear weight in the base station of the macrocell. Processing for multiplying a transmission signal by a linear weight may be referred to as “precoding”. The base station device of the macrocell may be referred to as “MeNB”, and the base station device of a picocell may be referred to as “PeNB”. Cells are used in this embodiment are a macrocell and picocells by way of example. However, any combination of cells, such as a combination of cells having different zone radii in which a desired signal for one cell causes interference for another cell, may be used. For example, cells and zones constituted by RRE (Remote Radio Equipments), femtocells (HeNB), hotspots, and relay stations, etc. may be used.

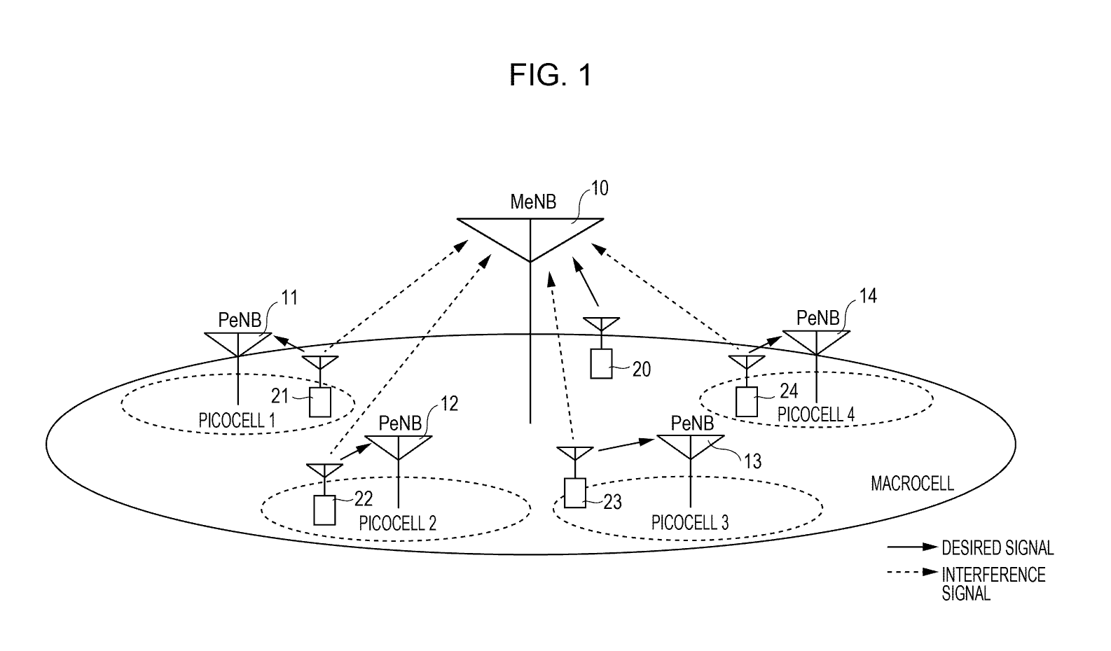

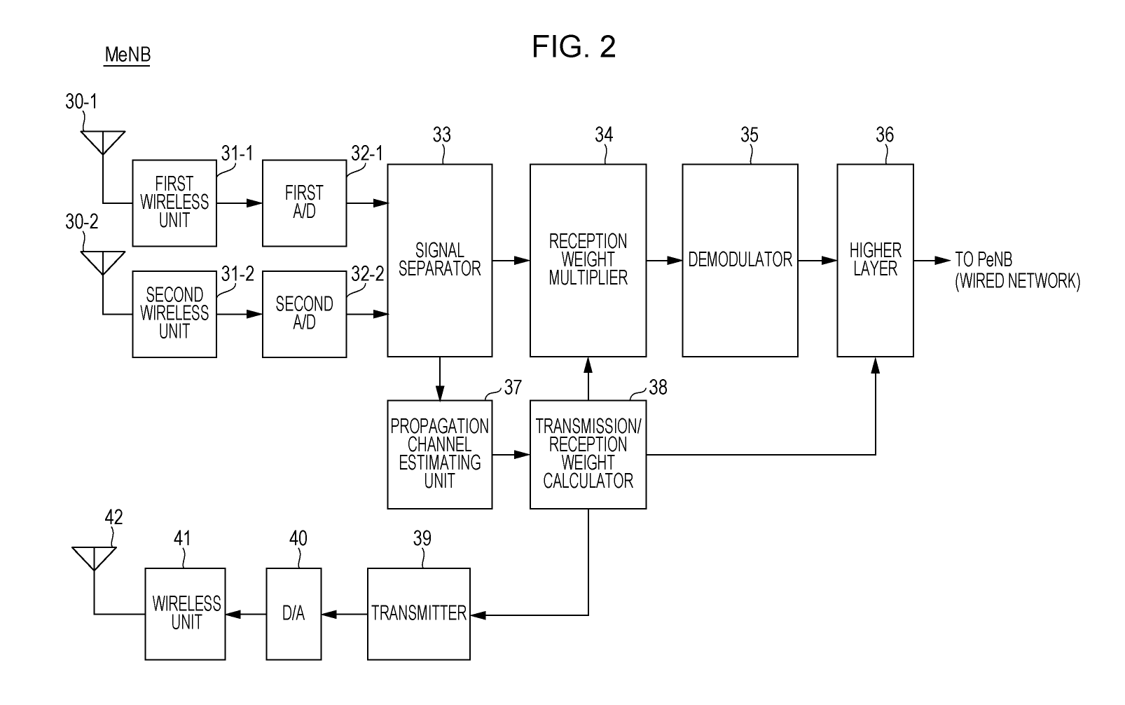

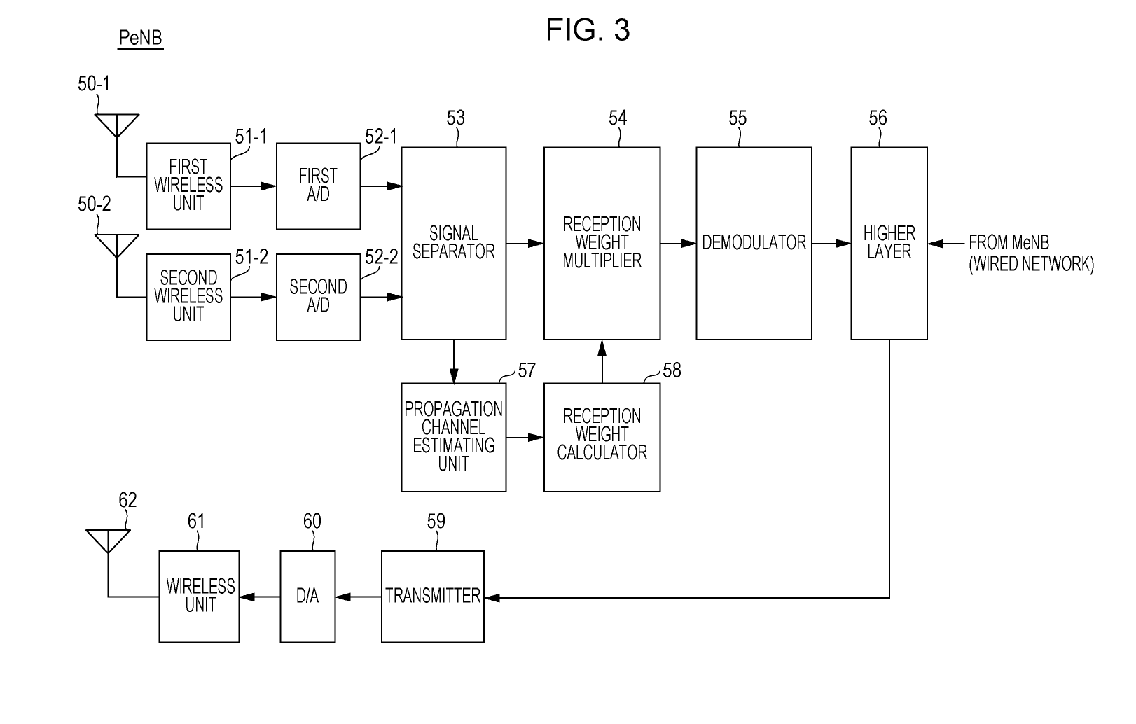

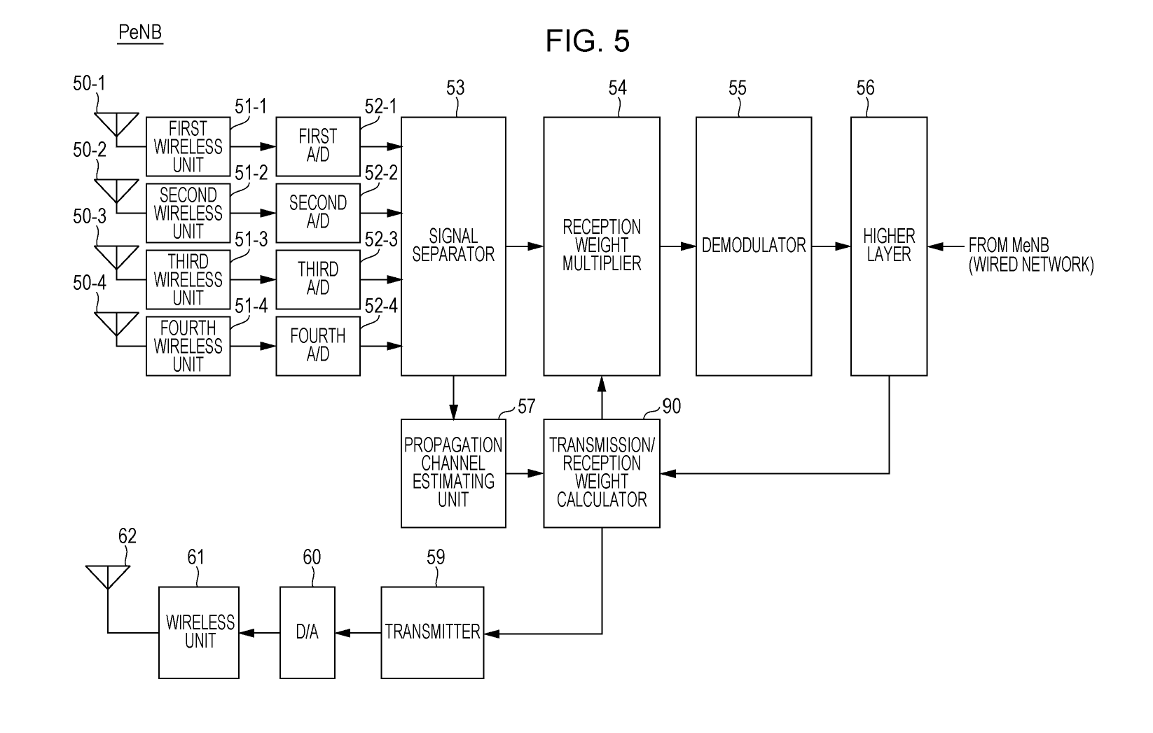

FIG. 1 illustrates an example of the configuration of a system used in this embodiment. In this embodiment, as shown in FIG. 1, a system in which four picocells (picocells 1 through 4) are present within one macrocell will be discussed by way of example. A MeNB 10 which controls the entire macrocell has two reception antennas (see FIG. 2) and, it is assumed that the MeNB 10 performs communication with a macrocell terminal 20. Within the macrocell controlled by the MeNB 10, PeNB 11 through PeNB 14 which control respective picocells are installed at positions at which they are separate from each other by a certain distance. The PeNB 11 through the PeNB 14 each have two antennas (see FIG. 3). The PeNB 11 through the PeNB 14 perform communication with picocell terminals 21 through 24, respectively. It is assumed that all the terminals (the macrocell terminal 20 and the picocell terminals 21 through 24) each have two transmission antennas (see FIG. 5).

In this situation, when observing the uplink transmission of each cell (macrocell or picocell), as shown in FIG. 1, the MeNB 10 receives interference from the picocell terminals 21 through 24. The MeNB 10 receives a total of five signals, that is, one desired signal from the macrocell terminal 20 and four interference signals from the picocell terminals 21 through 24. However, since the MeNB 10 has only two reception antennas, the degrees of freedom necessary for separating the signals from each other and extracting the desired signal are not sufficient.

Interference may occur between picocells. However, PeNBs are installed at lower positions than MeNB, and it is unlikely that line-of-sight communication will be performed between the terminal of a certain picocell and the PeNB of another picocell, and thus, there may be only a small level of interference between picocells. Similarly, there may also be only a small level of interference received by the PeNBs from the macrocell terminal. In this embodiment, therefore, a description will be given of control for making it easy for the MeNB 10 to eliminate interference received by the MeNB 10 from a plurality of picocell terminals (picocell terminals 21 through 24).

As stated above, in the situation shown in FIG. 1, a total of five signals, that is, one desired signal from the macrocell terminal 20 and four interference signals from the picocell terminals 21 through 24, reach the MeNB 10. However, the MeNB 10 has only two reception antennas, and since there is only one degree of freedom, that is, since the number of interference signals that can be eliminated is one, the degrees of freedom necessary for separating the signals from each other and extracting the desired signal are not sufficient. In this manner, in the MeNB 10 having one degree of freedom, in order to eliminate four interference signals by using a simple linear reception weight, it is necessary to perform control so that all of equivalent propagation channels of the four received interference signals will be orthogonal to the reception weight.

Accordingly, in this embodiment, the MeNB 10 first calculates a reception weight for extracting the desired signal transmitted from the macrocell terminal 20, and then calculates transmission weights to be used by the picocell terminals 21 through 24 for transmission so that equivalent propagation channels will be orthogonal to the determined reception weight. These calculations are performed by the MeNB 10 on the basis of information concerning a propagation channel between the macrocell terminal 20 and the MeNB 10 and information concerning a propagation channel between each of the picocell terminals 21 through 24 and the MeNB 10. The MeNB 10 then notifies the picocell terminals 21 through 24 of the transmission weights to be used by the picocell terminals 21 through 24 for transmission via the respective PeNBs of the picocell terminals 21 through 24.

A calculation method for these transmission and reception weights will be specifically described below. First, the propagation channel between the macrocell terminal 20 of the macrocell and the MeNB 10 is set to be H_{M}, the propagation channel between the picocell terminal 21 of the picocell 1 and the PeNB 11 is set to be H_{P1}, the propagation channel between the picocell terminal 22 of the picocell 2 and the PeNB 12 is set to be H_{P2}, the propagation channel between the picocell terminal 23 of the picocell 3 and the PeNB 13 is set to be H_{P3}, and the propagation channel between the picocell terminal 24 of the picocell 4 and the PeNB 14 is set to be H_{P4}. Moreover, the propagation channel between the picocell terminal 21 and the MeNB 10 is set to be H_{P1M}, the propagation channel between the picocell terminal 22 and the MeNB 10 is set to be H_{P2M}, the propagation channel between the picocell terminal 23 and the MeNB 10 is set to be H_{P3M}, and the propagation channel between the picocell terminal 24 and the MeNB 10 is set to be H_{P4M}. The eNBs and the terminals in this embodiment each have two antennas, and thus, the above-described propagation channels are each represented by a two-row and two-column matrix. Among these propagation channels, the MeNB 10 has estimated the propagation channels between the terminal devices and the MeNB 10 before data transmission is performed in each cell, and fluctuations in propagation channels caused by a time difference between the time at which propagation channel estimation is performed and the time at which data transmission is performed can be ignored.

First, the MeNB 10 calculates transmission and reception weights used for data transmission performed by the macrocell terminal 20. In this embodiment, it is assumed that the macrocell terminal 20 transmits one data stream (also called a rank). Transmission and reception weights used in the macrocell may be calculated by any method, and as an example, vectors obtained by performing SVD (Singular Value Decomposition) on the transmission channel H_{M} are used as transmission and reception weights. The SVD performed on the propagation channel H_{M} is represented by equation (1).

[Math. 1]

H_{M}=U_{M}D_{M}V_{M}^{H} (1)

In equation (1), each of U_{M} and V_{M} is a two-row and two-column unitary matrix, and D_{M} is a two-row and two-column diagonal matrix having positive real numbers as elements. The superscript H of V_{M} denotes complex conjugate transpose.

In a case in which the results of performing SVD on the propagation channel H_{M} are represented by equation (1), in this embodiment, as a transmission weight, a right-singular vector corresponding to the maximum singular value, that is, the first column vector of V_{M}, is used. As a reception weight, the complex conjugate transpose of a left-singular vector corresponding to the maximum singular value, that is, a complex conjugate transpose vector of the first column vector of U_{M}, is used. In this case, if the first column vector of U_{M} is U_{M1} and the first column vector of V_{M} is V_{M1}, the transmission weight used in the macrocell terminal 20 is V_{M1}, and the reception weight used in the MeNB 10 is U_{M1}^{H}. By the use of such transmission and reception weights, transmission is performed such that the gain corresponding to the maximum singular value of the propagation channel H_{M} can be obtained for a desired signal.

In this manner, the MeNB 10 first calculates the transmission weight used by the macrocell terminal 20 and the reception weight used by the MeNB 10 itself, and calculates a transmission weight used by a picocell terminal within each picocell on the basis of the calculated reception weight. If an equivalent propagation channel of an interference signal reaching the MeNB 10 from each picocell terminal is orthogonal to the reception weight U_{M1}^{H} calculated as described above, it is possible to extract a desired signal while eliminating the interference by multiplying a signal received by the MeNB 10 by the reception weight U_{M1}^{H}. Then, the MeNB 10 calculates a transmission weight used by each picocell terminal in order to perform control so that an equivalent propagation channel of an interference signal transmitted from the picocell terminal will be orthogonal to the reception weight U_{M1}^{H}. For calculating a transmission weight, a vector orthogonal to the reception weight U_{M1}^{H} is first determined.

There are several methods for calculating a vector orthogonal to the reception weight U_{M1}^{H}. The simplest is a method utilizing the results of equation (1). This method is based on the fact that the first column vector and the second column vector are orthogonal to each other since U_{M} in equation (1) is a two-row and two-column unitary matrix. Accordingly, if the second column vector of U_{M} in equation (1) is indicated by U_{M2}, the vector orthogonal to the reception weight U_{M1}^{H} can be set to be U_{M2}.

Alternatively, instead of using this method, a method for determining a vector orthogonal to the reception weight U_{M1}^{H} by using the results of performing SVD on the reception weight U_{M1}^{H} may be employed. The SVD performed on the reception weight U_{M1}^{H} is expressed by equation (2).

[Math. 2]

U_{M1}^{H}=U′_{M1}D′_{M1}V′_{M1}^{H} (2)

Since the reception weight U_{M1}^{H} is represented by one-row and two-column vectors, U_{M1}′ is 1, and V_{M1}′ is a two-row and two-column unitary matrix in equation (2). D_{M1}′ is represented by one-row and two-column vectors having positive real numbers and zero as elements. Among the two column vectors of V_{M1}′ obtained in this manner, if both sides of equation (2) are multiplied by the second column vector from the right, the right side of the multiplication results is zero. Accordingly, if the second vector of V_{M1}′ is indicated by be V_{M12}′, it can be said that V_{M12}′ is a vector orthogonal to the reception weight U_{M1}^{H}.

By using these methods, a vector (the above-described U_{M2} or V_{M12}′) orthogonal to the reception weight U_{M1}^{H} is obtained. Then, a transmission weight used in each picocell terminal which makes an equivalent propagation channel of an interference signal transmitted from the picocell terminal be represented by the above-described vector is calculated. If the picocell terminal 21 is taken as an example, this can be implemented by calculating a transmission weight V_{P1} which satisfies the following equation (3). In this case, it is assumed that U_{M2} is used as a vector orthogonal to the reception weight U_{M1}^{H}.

[Math. 3]

U_{M2}=H_{P1M}V_{P1} (3)

The propagation channel matrix H_{P1M} is a two-row and two-column matrix, and each of the elements of the matrix is an independent Gaussian variable. Accordingly, it can be said that, generally, H_{P1M} has an inverse matrix. Thus, the transmission weight V_{P1} which satisfies the following equation (3) can be found by V_{P1}=H_{P1M}⁻¹ U_{M2}.

Similarly, the transmission weight V_{P2} used in the picocell terminal 22 can be found by V_{P2}=H_{P2M}⁻¹ U_{M2}. The transmission weight V_{P3} used in the picocell terminal 23 can be found by V_{P3}=H_{P3M}⁻¹ U_{M2}. The transmission weight V_{P4} used in the picocell terminal 24 can be found by V_{P4}=H_{P4M}⁻¹ U_{M2}.

Transmission data signals are multiplied by the corresponding transmission weights calculated as described above, and are then transmitted from the associated picocell terminals. Then, equivalent propagation channels of these signals received by the MeNB 10 are all represented by U_{M2}. The equivalent propagation channels U_{M2} are orthogonal to the reception weight U_{M1}^{H}, which is used for receiving a signal from the macrocell terminal 20 by the MeNB 10. Accordingly, by using these transmission and reception weights, even when the macrocell terminal 20 and the picocell terminals 21 through 24 perform transmission at the same time by using the same resource, the MeNB 10 is able to extract a desired signal from the macrocell terminal 20 while eliminating the influence of interference signals transmitted from the picocell terminals.

In this embodiment, all the weights are calculated in the MeNB 10, and among the weights, the MeNB 10 notifies the macrocell terminal 20 of the transmission weight V_{M1} used in the macrocell terminal 20. The MeNB 10 notifies, via a wired network, the individual PeNBs of the transmission weights (V_{P1}, V_{P2}, V_{P3}, V_{P4}) used in the respective picocell terminals, and then, the PeNBs notify the picocell terminals included in the associated PeNBs of the transmission weights. By informing the individual terminal devices of the associated weights calculated by the MeNB 10 in this manner, the terminal devices are able to use the associated transmission weights when transmitting data. When supplying information concerning the transmission weights, information obtained by quantizing the weights may be supplied.

The device configuration of the MeNB 10 which calculates such transmission and reception weights is shown in FIG. 2. The MeNB 10 of this embodiment includes, as shown in FIG. 2, first and second reception antennas 30-1 and 30-2, first and second wireless units 31-1 and 31-2, a wireless unit 41, first and second A/D units 32-1 and 32-2, a signal separator 33, a reception weight multiplier 34, a demodulator 35, a higher layer 36, a propagation channel estimating unit 37, a transmission/reception weight calculator 38, a transmitter 39, a D/A unit 40, and a transmission antenna 42. The MeNB of this embodiment has two reception antennas, and has a dual system, each being constituted by a reception antenna, a wireless unit, and an A/D unit, as described above. It is noted that FIG. 2 shows the device configuration of the MeNB when single carrier transmission is performed.

As stated above, in the MeNB shown in FIG. 2, prior to data transmission performed by the terminal devices, the MeNB first receives known propagation channel estimating signals for estimating propagation channels (H_{M}, H_{P4M}, H_{P2M}, H_{P3M}, H_{P4M}) between the MeNB and the individual terminal devices. It is assumed that the propagation channel estimating signals for estimating the propagation channels between the MeNB and the terminal devices are not multiplexed with data signals, and also that the propagation channel estimating signals transmitted from the individual terminal devices are orthogonal to each other, for example, in a time domain, and do not interfere with each other.

The propagation channel estimating signals are received by the reception antennas 30, and are subjected to frequency conversion in the wireless units 31 such that a wireless frequency is converted to a frequency that can be subjected to analog/digital conversion. Then, the signals are subjected to analog/digital conversion in the A/D units 32. The propagation channel estimating signals converted into digital signals in the A/D units 32 are input into the signal separator 33. If the signals used for propagation channel estimation and data signals are multiplexed with each other, the signal separator 33 performs processing for separating these signals from each other. However, since the propagation channel estimating signals are not multiplexed with data signals, the signal separator 33 performs processing for outputting the propagation channel estimating signals to the propagation channel estimating unit 37.

The propagation channel estimating unit 37 estimates propagation channels between the MeNB and the individual terminal devices on the basis of the received propagation channel estimating signals. In this case, H_{M}, H_{P1M}, H_{P2M}, H_{P3M}, H_{P4M} described above are estimated. The propagation channels between the MeNB and the individual terminal devices estimated in this manner are input into the transmission/reception weight calculator 38. The transmission/reception weight calculator 38 calculates, on the basis of the input propagation channels, a reception weight used by the MeNB 10 itself, a transmission weight used by the macrocell terminal 20, and transmission weights used by the picocell terminals 21 through 24. The reception weight (U_{M1}^{H}) used by the MeNB 10 itself and the transmission weight (V_{M1}) used by the macrocell terminal 20 can be calculated, for example, by performing an operation expressed by equation (1), as stated above. The transmission weights (V_{P1}, V_{P2}, V_{P3}, V_{P4}) used by the picocell terminals 21 through 24 can be found, for example, on the basis of equation (3). Among the transmission and reception weights calculated in this manner, the reception weight used by the MeNB 10 itself is output to the reception weight multiplier 34, the transmission weight used by the macrocell terminal 20 is output to the transmitter 39, and the transmission weights used by the picocell terminals 21 through 24 are output to the higher layer 36.

The reception weight multiplier 34 holds the reception weight input from the transmission/reception weight calculator 38 until a data signal is received so as to multiply a data signal by the reception weight when the data signal is received.

In order to notify the macrocell terminal 20 of the transmission weight to be used by the macrocell terminal 20, the transmitter 39 performs processing for converting the transmission weight into a signal format that can be transmitted. After being subjected to the processing performed by the transmitter 39, information concerning the transmission weight to be used by the macrocell terminal 20 is subjected to digital/analog conversion in the D/A unit 40, and is converted to a frequency that can be wirelessly transmitted by the wireless unit 41. Then, the information is transmitted to the macrocell terminal 20 from the transmission antenna 42. In this configuration, the number of transmission antennas is one, but a plurality of transmission antennas may be used.

In order to notify, via a wired network, the PeNBs connected to the MeNB of the transmission weights to be used by the picocell terminals 21 through 24, the higher layer 36 performs processing for converting the transmission weights into a format that can be transmitted via a wired network. Then, items of information concerning the transmission weights to be used by the picocell terminals 21 through 24 are transmitted to the individual PeNBs via a wired network.

By performing such processing, a propagation channel between the MeNB and each of the macrocell terminal and the picocell terminals is estimated, transmission and reception weights are calculated on the basis of the calculated propagation channels, and then, items of information concerning the calculated transmission and reception weights can be supplied. Then, upon receiving the items of information concerning the transmission weights used by the individual terminal devices, the terminal devices multiply transmission data signals by the transmission weights, and then perform data transmission by using the same resource. A description will now be given of an operation of the MeNB 10 when receiving these data signals. It is assumed that, in this embodiment, data transmission performed by the individual terminal devices is conducted in a format in which a demodulation propagation channel estimating signal is temporally multiplexed with a data signal. The demodulation propagation channel estimating signal is a known signal for estimating an equivalent propagation channel which is necessary to demodulate a data signal at a reception side, and is transmitted after being multiplied by the same transmission weight by which the data signal is multiplied.

When such data transmission is performed by the terminal devices, the MeNB 10 in this embodiment receive signals transmitted from all the terminal devices. Among these signals, however, for the MeNB 10, the signal transmitted from the macrocell terminal 20 is a desired signal, and the other signals transmitted from the picocell terminals are interference signals. That is, the MeNB 10 receives signals including both a desired signal and interference signals.

In the MeNB 10, the signals are received by the reception antennas 30 and are then subjected to frequency conversion in the wireless units 31 such that the wireless frequency is converted to a frequency that can be subjected to analog/digital conversion. The signals are then subjected to analog/digital conversion in the A/D units 32, and the digital signals are then input into the signal separator 33. As stated above, the received signals are signals in which demodulation propagation channel estimating signals are temporally multiplexed with data signals. Accordingly, the demodulation propagation channel estimating signals and the data signals are separated from each other in the signal separator 33. The demodulation propagation channel estimating signals separated by the signal processor 33 are input into the propagation channel estimating unit 37, while the data signals are input into the reception weight multiplier 34.

The propagation channel estimating unit 37 estimates an equivalent propagation channel of a received signal on the basis of the propagation channel estimating signal by which the same transmission weight as that multiplied by the data signal is multiplied. This equivalent propagation channel estimation may be performed only for a desired signal transmitted from the terminal of the MeNB 10, that is, from the macrocell terminal 20. Alternatively, if the demodulation propagation channel estimating signals transmitted from the picocell terminals can be received without interfering with the demodulation propagation channel estimating signal of the desired signal, the equivalent propagation channel estimation may also be performed on the signals transmitted from the picocell terminals. The estimation results of the equivalent propagation channels are input into the transmission/reception weight calculator 38, and a reception weight is calculated on the basis of the equivalent propagation channel estimated from the demodulation propagation channel estimating signal.

This calculation of a reception weight is performed for estimating the latest propagation channel, in a situation in which the propagation channel has significantly changed from that when the reception weight U_{M1}^{H} was previously calculated. The reception weight can be calculated on the basis of, for example, MMSE (Minimum Mean Square Error). In this case, if, not only the equivalent propagation channel of the signal transmitted from the macrocell terminal 20, but also the equivalent propagation channels of the signals transmitted from the picocell terminals can be estimated, the reception weight based on MMSE can be represented by expression (4). In expression (4) H_{Meq}=H_{M}V_{M1}, H_{P1eq}=H_{P1M}V_{P1}, H_{P2eq}=H_{P2M}V_{P2}, H_{P3eq}=H_{P3M}V_{P3}, and H_{P4eq}=H_{P4M}V_{P4}, and σ² is the reciprocal of the average reception SNR (Signal to Noise power Ratio) or the variance of noise, and I is an identify matrix.

[Math. 4]

H_{Meq}^{H}(H_{Meq}H_{Meq}^{H}+H_{P1eq}H_{P1eq}^{H}+H_{P2eq}H_{P2eq}^{H}+H_{P3eq}H_{P3eq}^{H}+H_{P4eq}H_{P4eq}^{H}+σ²I)⁻¹ (4)

In this manner, in a situation in which the propagation channel is fluctuated due to a time difference between the time at which the above-described H_{M}, H_{P1M}, H_{P2M}, H_{P3M}, H_{P4M} are estimated and the time at which the actual data transmission is performed, equivalent propagation channels (H_{Meq}, H_{P1eq}, H_{P2eq}, H_{P3eq}, H_{P4eq}) may be estimated by using demodulation propagation channel estimating signals multiplexed with data signals, and on the basis of the estimation results, a new reception weight may be recalculated by using expression (4).

If transmission is performed by using transmission weights which are autonomously calculated in the picocell terminals, all interference signals reaching the MeNB 10 are entirely independent, and thus, it is not possible to obtain good reception characteristics even if a reception weight calculated by expression (4) is used. In contrast, in this embodiment, the MeNB 10 calculates favorably for the MeNB 10 all transmission weights used in the individual picocell terminals. Accordingly, even in a situation in which it is not possible to ignore time fluctuations in propagation channels, the influence of the time fluctuations can be reduced by using expression (4), thereby making it possible to extract a desired signal with high precision. Instead of using expression (4), a reception weight may be calculated and used on the basis of MMSE by using only the equivalent propagation channel (H_{Meq}) in the cell of the MeNB 10.

Unlike the above-described situation, if the estimated propagation channels H_{M}, H_{P1M}, H_{P2M}, H_{P3M}, H_{P4M} are substantially the same as the propagation channels when actual data transmission is performed, the previously calculated reception weight U_{M1}^{H} can be used. In this manner, regardless of whether the reception weight U_{M1}^{H} which is calculated at the same time as the calculation of transmission weights (equation (1) or equation (3)) to be used in the macrocell 20 and picocell terminals is used, or whether the reception weight is recalculated as represented by expression (4), a desired signal can be extracted while suppressing the influence of interference signals transmitted from the picocell terminals.

The extraction of a desired signal is performed in the reception weight multiplier 34. In the reception weight multiplier 34, a received data signal is multiplied by the reception weight U_{M1}^{H} or a reception weight represented by expression (4), thereby extracting a desired signal while suppressing the interference. Then, a data signal extracted by the reception weight multiplier 34 is demodulated in the demodulator 35, and demodulated information data is supplied to the higher layer 36.

With the above-described configuration of the MeNB, not only a transmission weight used by the macrocell 20, but also transmission weights used by the picocell terminals 21 through 24 can be calculated, and items of information concerning the calculated transmission weights can be supplied to the macrocell terminal 20 and the PeNBs, which are communication parties of the associated picocell terminals. Then, when transmission using such transmission weights is performed, a signal from the macrocell terminal 20, which is a desired signal, can be extracted while suppressing interference signals transmitted from the picocell terminals.

The device configuration of the PeNB of this embodiment is shown in FIG. 3. The PeNB of this embodiment includes, as shown in FIG. 3, reception antennas 50-1 and 50-2, first and second wireless units 51-1 and 51-2, a wireless unit 61, first and second A/D units 52-1 and 52-2, a signal separator 53, a reception weight multiplier 54, a demodulator 55, a higher layer 56, a propagation channel estimating unit 57, a reception weight calculator 58, a transmitter 59, a D/A unit 60, and a transmission antenna 62. As in the MeNB, the PeNB of this embodiment has two reception antennas, and has a dual system, each being constituted by a reception antenna 50, a wireless unit 51, and an A/D unit 52. It is noted that FIG. 3 shows the device configuration of the PeNB when single carrier transmission is performed.

In the PeNB shown in FIG. 3, prior to data transmission performed by a terminal device, processing is performed in which information concerning a transmission weight calculated in the MeNB and to be used in a picocell terminal is obtained from the MeNB and is supplied to the picocell terminal, which is a communication party of the PeNB. This information is obtained via a wired network, and is first input into the higher layer 56. The information concerning the transmission weight input into the higher layer 56 is input into the transmitter 59. In the transmitter 59, processing is performed for converting the transmission weight into a signal format which can be transmitted. After being subjected to the processing in the transmitter 59, the information concerning the transmission weight used in the picocell terminal is subjected to digital/analog conversion in the D/A unit 60. The information is then subjected to frequency conversion in the wireless unit 61 such that the frequency is converted to a frequency that can be wirelessly transmitted. Then, the information is transmitted from the transmission antenna 62 to the picocell terminal. In this configuration, the number of transmission antennas is one, but a plurality of transmission antennas may be used.

By performing the above-described processing, information concerning a transmission weight calculated in the MeNB and to be used in a picocell terminal can be obtained and supplied to the picocell terminal. Then, the picocell terminal transmits data to the associated PeNB by using the received transmission weight. As stated above, in this embodiment, it is assumed that the macrocell terminal 20 and the picocell terminals 21 through 24 perform data transmission at the same time by using the same resource.

In the PeNB, a data signal transmitted in this manner is received by the reception antenna 50. Then, the data signal is subjected to frequency conversion in the wireless unit 51 such that a wireless frequency is converted to a frequency that can be subjected to analog/digital conversion. The data signal is then subjected to analog/digital conversion in the A/D unit 52, and the digital signal is input into the signal separator 53. As in a received signal in the MeNB, this received signal is a signal in which a demodulation propagation channel estimating signal is temporally multiplexed with a data signal. Thus, the demodulation propagation channel estimating signal and the data signal are separated from each other in the signal separator 53. The demodulation propagation channel estimating signal separated in the signal separator 53 is input into the propagation channel estimating unit 57, while the data signal is input into the reception weight multiplier 54.

The propagation channel estimating unit 57 estimates an equivalent propagation channel of a received desired signal, on the basis of the propagation channel estimating signal which is multiplied by the same transmission weight as that by which the data signal is multiplied and which is transmitted from the terminal of the picocell of the PeNB, that is, a picocell terminal, which is a communication party of the PeNB. However, if the reception levels of interference signals transmitted from the other cells (macrocell and picocells) are equal to or higher than a certain level, and if equivalent propagation channels of these interference signals can be estimated, they may be estimated as well as the equivalent propagation channel of the desired signal. The estimation results of the equivalent propagation channels are input into the transmission/reception weight calculator 38 (FIG. 2), and a reception weight is calculated on the basis of the equivalent propagation channel estimated from the demodulation propagation channel estimating signal. This reception weight is a weight for compensating for the equivalent propagation channel by which a desired signal transmitted from the picocell terminal, which is a communication party of the PeNB, is multiplied. For example, if the equivalent propagation channel estimated in the PeNB 11 is indicated by H_{P1}V_{P1}, the reception weight can be calculated by expression (5).

[Math. 5]

(H_{P1}V_{P1})^{H} (5)

By using expression (5), a reception weight which implements maximum ratio combining of signals received by two reception antennas of the PeNB is obtained. By using this reception weight, good reception characteristics can be obtained while compensating for the phase. If the amplitude of a received signal is also compensated for, a signal multiplied by the above-described reception weight is divided by the square of the absolute value of the equivalent propagation channel.

In addition to the reception weight represented by expression (5), a reception weight based on MMSE may be calculated. The reception weight calculated on the basis of MMSE is represented by expression (6).

[Math. 6]

(H_{P1}V_{P1})^{H}[(H_{P1}V_{P1})(H_{P1}V_{P1})^{H}+σ²I]⁻¹ (6)

The reception weight calculated by using expression (5) or (6) is input into the reception weight multiplier 54. By multiplying a received signal by this reception weight, the reception weight multiplier 54 compensates for the equivalent propagation channel of the received signal and extracts a desired data signal. The data signal extracted by the reception weight multiplier 54 is demodulated in the demodulator 55, and the demodulated information data is supplied to the higher layer 56.

With the above-described configuration of the PeNB, information concerning a transmission weight to be used in the picocell terminal can be obtained from the MeNB and can be supplied to the picocell terminal. Then, in the picocell terminal, when data transmission is performed by using the transmission weight, a desired signal can be extracted and demodulated.

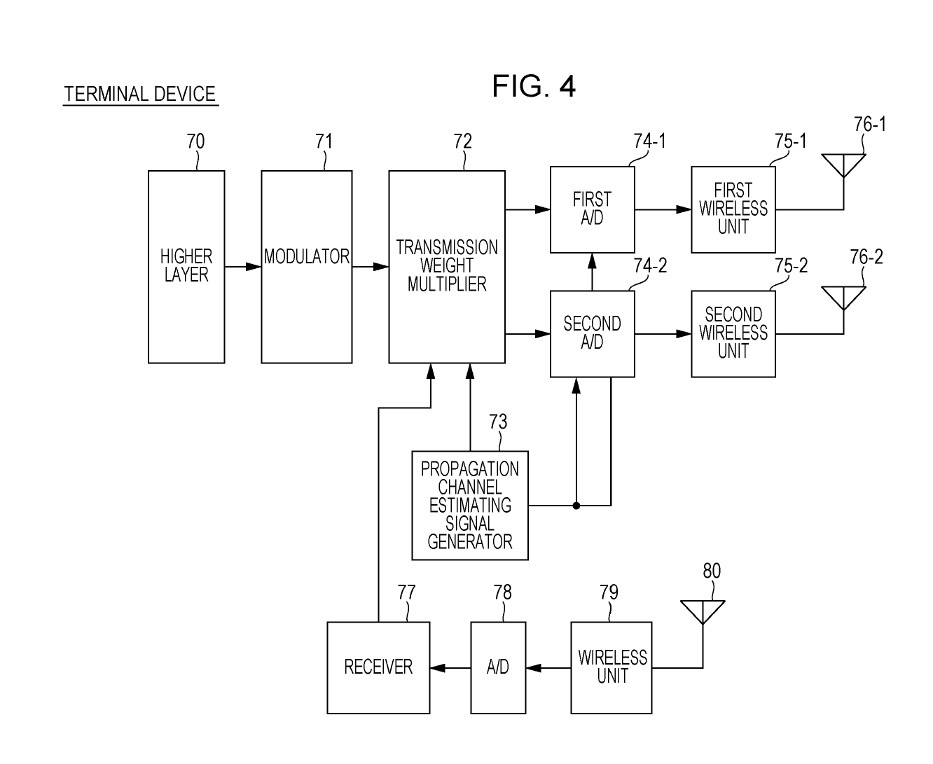

The configuration of a terminal device of this embodiment is shown in FIG. 4. The terminal device of this embodiment includes, as shown in FIG. 4, a higher layer 70, a modulator 71, a transmission weight multiplier 72, a propagation channel estimating signal generator 73, first and second D/A units 74-1 and 74-2, first and second wireless units 75-1 and 75-2, a wireless unit 79, transmission antennas 76-1 and 76-2, a receiver 77, an A/D unit 78, and a reception antenna 80. In this embodiment, there are a macrocell terminal which performs communication with the MeNB and picocell terminals which perform communication with PeNBs, and the configuration shown in FIG. 4 is used for all of the macrocell terminal and the picocell terminals.

Prior to data transmission, the terminal device shown in FIG. 4 transmits a known propagation channel estimating signal for enabling the MeNB to estimate an associated one of propagation channels (H_{M}, H_{P1M}, H_{P2M}, H_{P3M}, H_{P4M}) between the terminal device and the MeNB. This propagation channel estimating signal is generated in the propagation channel estimating signal generator 73, and is subjected to digital/analog conversion in the D/A unit 74 and is then subjected to frequency conversion in the wireless unit 75 such that the frequency is converted to a frequency that can be wirelessly transmitted. Then, the propagation channel estimating signal is transmitted from the transmission antenna 76. However, this propagation channel estimating signal is not multiplexed with a data signal, and propagation channel estimating signals transmitted from a plurality of terminal devices are orthogonal to each other in a time domain and do not interfere with each other.

The propagation channel estimating signals transmitted as described above are received by the MeNB, and as stated above, propagation channels between the individual terminal devices and the MeNB are estimated on the basis of the received propagation channel estimating signals, and then, transmission weights to be used in the individual terminal devices are calculated. Items of information concerning the transmission weights calculated in the MeNB and to be used in the individual terminal devices are supplied from the MeNB to the terminal devices. In this embodiment, information concerning the transmission weight to be used in the macrocell terminal 20 is directly supplied from the MeNB to the macrocell terminal 20 through wireless transmission, and items of information concerning the transmission weights to be used in the picocell terminals are supplied from the MeNB to the PeNBs, and are then supplied from the PeNBs to the picocell terminals through wireless transmission.

Information concerning the transmission weight calculated in the MeNB is received by the reception antenna 80, and is subjected to frequency conversion in the wireless unit 79 such that the wireless frequency is converted to a frequency that can be subjected to analog/digital conversion. Then, the information is subjected to analog/digital conversion and is converted to a digital signal in the A/D unit 78. The information concerning the transmission weight converted to the digital signal is then input into the receiver 77 and is converted to a format that can be used in the associated terminal device. Then, the transmission weight is input into the transmission weight multiplier 72. By using this transmission weight, data is transmitted to the associated eNB, which is the communication party of the terminal device. Data to be transmitted is generated in the higher layer 70 and is modulated in the modulator 71 by using a modulation method, such as QPSK or 16QAM.

The modulated data signal is input into the transmission weight multiplier 72 and is multiplied by the transmission weight input from the receiver 77. In this transmission weight multiplier 72, a demodulation propagation channel estimating signal is also multiplied by the transmission weight, thereby generating a propagation channel estimating signal multiplied by the same transmission weight as that by which the data signal is multiplied. The known demodulation propagation channel estimating signal is generated in the propagation channel estimating signal generator 73, and is then input into the transmission weight multiplier 72. The demodulation propagation channel estimating signal is then multiplied by the transmission weight. In this embodiment, the demodulation propagation channel estimating signal generated as described above is temporally multiplexed with the data signal. Then, the multiplexed signal is subjected to digital/analog conversion in the D/A unit 74 and is subjected to frequency conversion in the wireless unit 75 such that the frequency is converted to a frequency that can be wirelessly transmitted. Then, the signal is transmitted from the transmission antenna 76.

With this configuration of the terminal device, a propagation channel estimating signal for enabling the MeNB to estimate the propagation channel between the MeNB and the terminal device is transmitted, and a transmission weight used for performing data transmission is received. Then, data transmission using this transmission weight can be performed. A transmission weight used by each terminal device has been generated in the MeNB for enabling the MeNB to extract a desired signal while eliminating interference signals transmitted from the picocell terminals. Thus, each terminal device performs data transmission by using the associated transmission weight, thereby enabling the MeNB to extract a desired signal even in a situation in which the MeNB receives interference from the picocell terminals.

In this embodiment, an example in which the number of reception antennas of each of the MeNB and PeNBs is two and the number of transmission antennas of each terminal device is two has been discussed. However, this embodiment is applicable even if the number of antennas is not two. For example, the number of reception antennas of each of the MeNB and PeNBs may be four and the number of transmission antennas of each terminal device may be two, or the number of reception antennas of each of the MeNB and PeNBs may be four and the number of transmission antennas of each terminal device may be four. Even in such a case, control can be performed so that a transmission weight orthogonal to a reception weight used by the MeNB will be calculated and information concerning the transmission weight will be supplied to the associated picocell terminal and be used for performing data transmission in the associated picocell terminal. However, in this case, it is necessary to set the number of transmission streams such that the degrees of freedom in the MeNB are sufficient for removing interference signals transmitted from picocell terminals, that is, the number of reception antennas in the MeNB is greater than the number of streams (ranks) transmitted from the macrocell terminal.

In this embodiment, a single picocell terminal installed in a picocell transmits data to the associated PeNB. However, a plurality of picocell terminals may transmit data to the associated PeNB. In this case, a propagation channel between the MeNB and each of the plurality of picocell terminals in one picocell is estimated in the MeNB, and on the basis of the estimated propagation channel and a reception weight used by the MeNB, a transmission weight used by each picocell terminal is calculated by using equation (3). It is now assumed that there are two picocell terminals, such as the picocell terminal 21 and a picocell terminal 25, in the picocell 1 shown in FIG. 1. In this case, if the propagation channel between the picocell terminal 21 and the MeNB is H_{P11M} and the propagation channel between the picocell terminal 25 and the MeNB is H_{P12M}, the transmission weight V_{P11} used by the picocell terminal 21 can be calculated to be V_{P11}=H_{P11M}⁻¹U_{M2}, and the transmission weight V_{P12} used by the picocell terminal 25 can be calculated to be V_{P12}=H_{P12M}⁻¹U_{M2} by using equation (3).

Items of information concerning the transmission weights calculated as described above are supplied from the MeNB to the picocell terminals 21 and 25 via the PeNB 11. Then, the picocell terminals perform data transmission by using the associated transmission weights. However, it is necessary for the PeNB, which receives different desired data signals from the two terminal devices, to separate these signals from each other and to demodulate them. Accordingly, as the reception weight, for example, [H_{P11P}V_{P11}H_{Pl2P}V_{P12}]⁻¹, is used.

With this configuration, it is possible to handle a case in which multiuser MIMO transmission is performed in which data is transmitted from a plurality of picocell terminals to a PeNB in a picocell.

### Second Embodiment

In the first embodiment, the following configuration has been discussed. In a situation in which the number of reception antennas of MeNB−1=the number of streams of a macrocell and the degrees of freedom of the MeNB are not sufficient, the MeNB specifies transmission weights used by individual picocell terminals. In contrast, if the number of reception antennas of MeNB−1>the number of streams of a macrocell and the degrees of freedom of the MeNB are sufficient, several candidates of transmission weights used by picocell terminals can be calculated by a relatively simple method. Since the transmission weight candidates are all orthogonal to a reception weight used by the MeNB, no matter which transmission weight is used, an interference signal transmitted from a picocell terminal can be eliminated by the MeNB. In this case, instead of the MeNB specifying transmission weights to be used in picocell terminals for transmission, the MeNB may notify a PeNB of several candidates of transmission weights, and the PeNB or the associated picocell terminal may specify a transmission weight from among the received transmission weight candidates. In this embodiment, such a configuration will be described.

In this embodiment, the number of reception antennas of each of the MeNB and PeNBs is four and the number of transmission antennas of each terminal device is four, and in a macrocell, one data stream is transmitted from the macrocell terminal to the MeNB. In each picocell, there is one picocell terminal, and each picocell terminal transmits one data stream to the associated PeNB. In this case, as in the first embodiment, the propagation channel between the macrocell terminal 20 of the macrocell and the MeNB 10 is set to be H_{M}, the propagation channel between the picocell terminal 21 of the picocell 1 and the PeNB 11 is set to be H_{P1}, the propagation channel between the picocell terminal 22 of the picocell 2 and the PeNB 12 is set to be H_{P2}, the propagation channel between the picocell terminal 23 of the picocell 3 and the PeNB 13 is set to be H_{P3}, the propagation channel between the picocell terminal 24 of the picocell 4 and the PeNB 14 is set to be H_{P4}, the propagation channel between the picocell terminal 21 and the MeNB 10 is set to be H_{P1M}, the propagation channel between the picocell terminal 22 and the MeNB 10 is set to be H_{P2M}, the propagation channel between the picocell terminal 23 and the MeNB 10 is set to be H_{P3M}, and the propagation channel between the picocell terminal 24 and the MeNB 10 is set to be H_{P4M}. In this case, the above-described propagation channels are each represented by a four-row and four-column matrix.

Among these propagation channels, on the basis of the propagation channel H_{M} between the macrocell terminal 20 and the MeNB 10, transmission and reception weights used in the macrocell are calculated. The calculations of transmission and reception weights may be performed by any method, and in this case, as in the first embodiment, SVD expressed by equation (1) is employed. If SVD expressed by equation (1) is performed on a four-row and four-column propagation channel H_{M}, each of U_{M} and V_{M} is calculated to be a four-row and four-column unitary matrix, and D_{M} is calculated to be a four-row and four-column diagonal matrix having positive real numbers as elements. If U_{M} is represented by U_{M}=[U_{M1} U_{M2} U_{M3} U_{M4}] and V_{M} is represented by V_{M}=[V_{M1} V_{M2} V_{M3} V_{M4}], and if the transmission weight used in the macrocell terminal 20 is V_{M1} and the reception weight used in the MeNB 10 is U_{M1}^{H}, transmission can be performed such that the gain corresponding to the maximum singular value of the propagation channel H_{M} can be obtained for a desired signal.

Since U_{M} calculated as described above is a unitary matrix, the columns of the matrix are represented by vectors orthogonal to each other. Accordingly, when the MeNB 10 utilizes U_{M1}^{H} as a reception weight, if equivalent propagation channels of interference signals transmitted from the picocell terminals are any one of U_{M2}, U_{M3}, and U_{M4}, the interference signals can be eliminated by the reception weight U_{M1}^{H}. Accordingly, transmission weights used in the individual picocell terminals are calculated on the basis of equation (3) so that equivalent propagation channels of interference signals reaching the MeNB 10 will be any one of U_{M2}, U_{M3}, and U_{M4}. In the first embodiment, since there is only one candidate of an equivalent transmission channel (only U_{M2} in equation (3)), equation (3) is constituted by only one equation. In this embodiment, however, since there are three candidates of equivalent transmission channels (U_{M2}, U_{M3}, U_{M4}), three equations are established, as expressed by equations (7).

[Math. 7]

U_{M2}=H_{P1M}V_{P11}

U_{M3}=H_{P1M}V_{P12}

U_{M4}=H_{P1M}V_{P13} (7)

Equations (7) are equations representing the relationships between transmission weight candidates (V_{P11}, V_{P12}, V_{P13}) used in the picocell terminal 21 within the picocell 1 and candidates of equivalent propagation channels (U_{M2}, U_{M3}, U_{M4}), respectively. By solving equations (7), such as V_{P11}=H_{P1M}⁻¹U_{M2}, V_{P12}=H_{P1M}⁻¹U_{M3}, and V_{P13}=H_{P1M}⁻¹U_{M4}, transmission weight candidates used in the picocell terminal 21 can be calculated. By performing the above-described calculations for interference signals transmitted from the individual picocell terminals, transmission weight candidates used in all the picocell terminals can be calculated.

Among the transmission weight candidates calculated as described above, the MeNB may specify which transmission weight will be used. In this embodiment, however, the MeNB notifies each PeNB of these candidates and allows each PeNB to specify a transmission weight to be used. Accordingly, the MeNB notifies, via a wired network, each PeNB of candidates of a transmission weight calculated on the basis of equations (7) and to be used in the associated picocell terminal. More specifically, the MeNB notifies each PeNB of three candidates, such as the MeNB notifies the PeNB 11 of V_{P11}, V_{P12}, V_{P13}, the PeNB 12 of V_{P21}, V_{P22}, V_{P23}, the PeNB 13 of V_{P31}, V_{P32}, V_{P33}, and the PeNB 14 of V_{P41}, V_{P42}, V_{P43}. V_{Pmn} denotes the n-th candidate of a transmission weight to be used in a picocell terminal within a picocell m.

In this manner, each PeNB is notified of candidates of a transmission weight to be used in the associated picocell terminal. Then, the PeNB specifies a transmission weight to be used from among these candidates. The PeNB specifies a transmission weight by selecting a transmission weight which achieves the highest reception quality of the PeNB from among the candidates. For example, in the picocell 1, the PeNB compares norms of results obtained by multiplying the propagation channel H_{P1} between the picocell terminal 21 and the PeNB 11 by each of the transmission weight candidates (V_{P11}, V_{P12}, V_{P13}), and then selects a transmission weight which obtains the largest norm value. This selecting operation is equal to selecting of a transmission weight which satisfies expression (8).

[Math. 8]

max(|H_{P1}V_{P11}∥², ∥H_{P1}V_{P12}∥², ∥H_{P1}V_{P13}∥²) (8)

By performing such a selecting operation in each PeNB, a transmission weight to be used in the associated picocell terminal can be specified, by considering the propagation channel of the picocell, so that good reception characteristics will be obtained in the PeNB. Then, each PeNB notifies the associated picocell terminal of the selected transmission weight, and the picocell terminal utilizes the transmission weight for data transmission. By allowing each picocell terminal to use such a transmission weight, an interference signal transmitted from the picocell terminal can be eliminated in the MeNB, and also, good transmission characteristics can be obtained in the picocell.

The MeNB of this embodiment can be implemented by using substantially the same configuration as that shown in FIG. 2. However, about four systems, each being constituted by a reception antenna 30, a wireless unit 31, and an A/D unit 32, are required (four systems, which are not shown, in contrast to a dual system, each being constituted by a reception antenna 30, a wireless unit 31, and an A/D unit 32, in FIG. 2). Additionally, the transmission/reception weight calculator 38 of the first embodiment calculates one transmission weight to be used by each picocell terminal, and notifies each PeNB of a calculated transmission weight. However, the transmission/reception weight calculator 38 of this embodiment calculates three candidates of a transmission weight to be used in each picocell terminal and notifies the associated PeNB of these candidates via a wired network.

The configuration of the PeNB in this embodiment is that shown in FIG. 5. The PeNB shown in FIG. 5 is substantially the same configuration as that shown in FIG. 3, and blocks performing the same processing operations as those of FIG. 3 are designated by like reference numerals. The configuration shown in FIG. 5 is different from that shown in FIG. 3 in that information concerning a plurality of transmission weight candidates is supplied from the MeNB. In this manner, the information concerning a plurality of transmission weight candidates is input into the higher layer 56, and is further input into the transmission/reception weight calculator 90 from the higher layer 56. The transmission/reception weight calculator 90 selects a transmission weight which satisfies expression (8) by using information concerning a propagation channel input from the propagation channel estimating unit 57 and information concerning the transmission weight candidates input from the higher layer 56. Then, information concerning the selected transmission weight is input into the transmitter 59 and is supplied to the picocell terminal by performing processing similar to that in FIG. 3. The transmission/reception weight calculator 90 also calculates a reception weight by using expression (5) or (6) and utilizes the calculated reception weight for extracting a desired signal when receiving data transmitted from the picocell terminal.

The terminal device of this embodiment can be implemented by using substantially the same configuration as that shown in FIG. 4. However, about four systems, each being constituted by a D/A unit 74, a wireless unit 75, and a transmission antenna 76, are required (four systems, which are not shown, in contrast to a dual system, each being constituted by a D/A unit 74, a wireless unit 75, and a transmission antenna 76, in FIG. 4).

With the above-described device configuration, the MeNB calculates candidates of a transmission weight to be used in each picocell terminal and notifies each PeNB of the transmission weight candidates. Then, each PeNB can specify a transmission weight to be actually used among these candidates. The PeNB then notifies the picocell terminal of the specified transmission weight, and the picocell terminal can perform data transmission by using this transmission weight.

In this embodiment, among candidates of a transmission weight calculated in the MeNB, a transmission weight to be actually used is specified by each PeNB. Alternatively, a transmission weight may be specified by each picocell terminal. In this case, each PeNB directly supplies information concerning transmission weight candidates supplied from the MeNB to the associated picocell terminal. Then, the picocell terminal selects a transmission weight favorable for the picocell terminal from among the transmission weight candidates, and performs data transmission by using the selected transmission weight.

Moreover, in this embodiment, a case in which one data stream is transmitted from one macrocell terminal to the MeNB has been discussed. However, transmission may be performed by a plurality of macrocell terminals. For example, if the number of macrocell terminals is two and each macrocell terminal transmits one stream, the MeNB utilizes a reception weight expressed by W_{MRX}=[W_{MRX1} W_{MRX2}]^{T} in order to extract two streams. Each of W_{MRX1} and W_{MRX2} is a four-row and one-column complex vector which satisfies W_{MRX1}≠kW_{MRX2} when k is a certain scalar.

If such a reception weight is utilized in the MeNB, the MeNB performs control so that equivalent propagation channels of interference signals transmitted from picocell terminals will be orthogonal to this reception weight, thereby making it possible to extract a desired signal while eliminating the influence of interference. Thus, it is necessary for the MeNB to first calculate vectors orthogonal to the reception weight W_{MRX}, and in this case, SVD is performed on W_{MRX}, thereby obtaining vectors orthogonal to the reception weight. If SVD is represented by W_{MRX}=PQR, each of R₃ and R₄ in a four-row and four-column unitary matrix R=[R₁, R₂, R₃, R₄] is a vector orthogonal to W_{MRX}. P is a two-row and two-column unitary matrix and Q is a two-row and two-column diagonal matrix. In this manner, two vectors orthogonal to the reception weight W_{MRX} can be obtained. Thus, the two vectors are substituted into equations (7) as candidates of equivalent propagation channels so as to calculate two candidates of a transmission weight to be used in the picocell terminal, and information concerning the calculated transmission weight candidates is supplied to the PeNB.

In the above-described example, the number of transmission weight candidates is three for each PeNB. However, in this example, the number of transmission weight candidates is two for each PeNB. In this manner, the number of transmission weight candidates calculated in the MeNB and reported to each PeNB differs depending on, for example, the number of transmission streams in a macrocell.

In this example, a case in which each of the two macrocell terminals transmits one stream has been discussed. Alternatively, one macrocell terminal may transmit a plurality of streams. In this case, too, the number of transmission weight candidates differs depending on, for example, the number of transmission streams. However, the MeNB can calculate transmission weight candidates and notify each PeNB of the calculated transmission weight candidates by performing processing similar to that described above.

As discussed in the first embodiment, in a picocell, data transmission may be performed from a plurality of picocell terminals to a PeNB, in which case, the PeNB selects a transmission weight suitable for each picocell terminal from among transmission weight candidates reported from the MeNB.

In the above-described two embodiments, by taking single carrier transmission as an example, a method for calculating a transmission weight used in a picocell terminal by the MeNB has been discussed. However, the present invention is not restricted to single carrier transmission, but may be applicable to multicarrier transmission. If the present invention is applied to multicarrier transmission, a transmission weight may be calculated for each sub carrier or for each group of several sub carriers.

In the uplink transmission, which is transmission from a terminal to an eNB, some systems employ single carrier transmission called DFT-spread OFDM using a plurality of sub carriers in order to reduce PAPR (Peak to Average Power Ratio) of a transmission signal. If such a transmission method is employed, in order to prevent PAPR characteristics from deteriorating, the same transmission weight used for all sub carriers and used by terminals for transmission may be calculated and used. Moreover, when such a transmission method is employed, if a certain transmission weight calculated on the basis of equation (3) or equations (7) is multiplied, PAPR of a transmission signal may be increased, which may deteriorate transmission characteristics.

However, such characteristic deterioration may occur in a terminal which is located at a position away from the MeNB and requires high transmission power. Accordingly, only in a terminal which requires relatively low transmission power, a certain transmission weight calculated on the basis of equation (3) or equations (7) may be used. In some systems, a transmission weight selected from among several transmission weights which have been determined so as not to deteriorate PAPR characteristics is used. In this case, such a transmission weight may be used only in a macrocell terminal which is likely to require high transmission power, and a certain transmission weight calculated on the basis of equation (3) or equations (7) may be used in a picocell terminal. By performing such control, while preventing PAPR characteristics in each terminal device from deteriorating, it is possible to eliminate interference signals transmitted from picocell terminals to the MeNB and to extract a desired signal by setting equivalent propagation channels of the interference signals to be orthogonal to a reception weight used in the MeNB.

In the above-described embodiments, the MeNB calculates a reception weight used by the MeNB and transmission weights used by individual picocell terminals. However, if there is a centralized control station which controls the MeNB and PeNBs, transmission and reception weights may be calculated in the centralized control station. The centralized control station is connected to the MeNB and PeNBs via a wired network, such as an optical fiber. Accordingly, via this wired network, the centralized control station is able to receive information concerning transmission channels, to calculate transmission and reception weights on the basis of the received information, and to supply information concerning a calculated weight to each eNB.

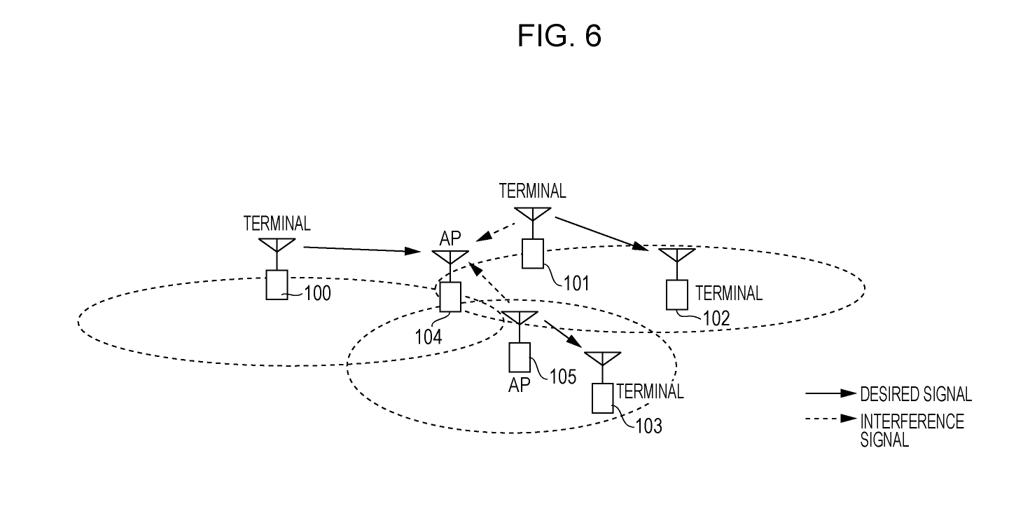

Further, the above-described embodiments are applied to a system in which picocells and femtocells with small zone radii are present within a macrocell. However, the above-described embodiments may be applicable to, for example, a wireless communication system in which communication ranges overlap each other, such as that shown in FIG. 6. FIG. 6 illustrates, by taking a wireless LAN (Local Area Network) as an example, a situation in which a terminal 100 transmits a signal to an AP (Access Point) 104, a terminal 101 transmits a signal to a terminal 102, and an AP 105 transmits a signal to a terminal 103. In this situation, it is assumed that the AP 104 receives interference from the terminal 101 and the AP 105. In this case, as in the above-described embodiments, the AP 104 may determine transmission weights used in the terminal 101 and the AP 105 so that equivalent transmission channels of interference signals reaching the AP 104 will be orthogonal to the reception weight used in the AP 104. Then, the AP 104 may notify the terminal 101 and the AP 105 of the respective transmission weights. In this example, the AP 104 determines transmission weights used in other devices. However, instead of the AP, a terminal may determine a transmission weight. The above-described configuration is valid, not only in a wireless LAN system, but also in a system in which many transmission and reception devices are present in a relatively narrow area. For example, this configuration is applicable to a case in which various electric home appliances are connected to each other via a wireless network.

In the above-described embodiments, the configurations and other features shown in the accompanying drawings are examples only, and they may be changed appropriately within a range in which advantages of the present invention are achieved, or may be changed appropriately and carried out within the spirit of the object of the present invention.

Moreover, processing of the individual elements may be performed in the following manner. A program for implementing the functions discussed in the embodiments may be recorded on a computer-readable recording medium, and a computer system may be caused to read and execute the program recorded on this recording medium. In this case, the term “computer system” includes an OS and hardware, such as peripheral devices.

“Computer system” also includes homepage providing environments (or displaying environments) if a WWW system is utilized.

The term “computer-readable recording medium” may be a portable medium, such as a flexible disk, a magneto-optical disk, a ROM, or a CD-ROM, or a storage device, such as a hard disk contained in a computer system. “Computer-readable recording medium” may also include a medium for dynamically retaining the program for a short period of time, such as a communication line used for transmitting the program via a network, such as the Internet, or a communication circuit, such as a telephone line, and may include a medium for temporarily retaining the program, such as a volatile memory within a computer system, which serves as a server or a client when the program is transmitted. The above-described program may be used for implementing some of the above-described functions, or for implementing the above-described functions together with a program which is already recorded on a computer system.

### INDUSTRIAL APPLICABILITY

The present invention is applicable to a communication apparatus.

### REFERENCE SIGNS LIST

10 MeNB, 11 to 14 PeNB, 20 to 24 terminal, 30-1, 2 antenna, 31-1, 2 first and second wireless units, 32-1, 2 first and second A/D, 33 signal separator, 34 reception weight multiplier, 35 demodulator, 36 higher layer, 37 propagation channel estimating unit, 38 transmission/reception weight calculator, 39 transmitter, D/A unit, 41 wireless unit, 42 transmission antenna, 50-1, 2 antenna, 51-1, 2 first and second wireless units, 52-1, 2 first and second A/D, 53 signal separator, 58 reception weight multiplier, 55 demodulator, 56 higher layer, 57 propagation channel estimating unit, 58 transmission/reception weight calculator, 59 transmitter, D/A unit, 61 wireless unit, 62 transmission antenna, higher layer, 71 modulator, 72 transmission weight multiplier, 73 propagation channel estimating signal generator, 74-1, 2 first and second D/A, 75-1, 2 first and second wireless units, 76-1, 2 antenna, 77 receiver, A/D, 79 wireless unit, 80 antenna, 90 transmission/reception weight calculator, 100 to 103 terminal, 104 to 105 AP

All of the publications, patents, and patent applications cited in this specification are incorporated herein by reference.

1-7. (canceled)

8. A first base station device,
wherein the first base station device supplies information concerning a transmission weight to a second base station device, the transmission weight being used by a terminal device which transmits a data signal to the second base station device.

9. The first base station device according to claim 8, wherein the first base station device supplies information concerning a plurality of transmission weights to the second base station device.

10. The first base station device according to claim 8, wherein the first base station device includes a propagation channel estimating unit that estimates a propagation channel between the first base station device and each terminal device on the basis of a received propagation channel estimating signal, and a transmission/reception weight calculator that calculates a transmission weight to be used by the terminal device which transmits a data signal to the second base station device on the basis of a propagation channel between the first base station device and each terminal device estimated by the propagation channel estimating unit.

11. A second base station device,
wherein the second base station device obtains information concerning a transmission weight from a first base station device, the transmission weight being used by a terminal device which transmits a data signal to the second base station device, and the second base station device supplies the obtained information concerning the transmission weight to the terminal device.

12. The second base station device according to claim 11, wherein the second base station device obtains information concerning a plurality of transmission weights from the first base station device, selects one transmission weight from among the plurality of transmission weights, and supplies information concerning the selected transmission weight to the terminal device.

13. A terminal device in a communication including a first cell and a second cell, the terminal device transmitting a data signal to a second base station device which controls the second cell,
wherein the terminal device transmits a data signal to the second base station device by using a transmission weight reported from a first base station device which controls the first cell to the second base station device.

14. The terminal device according to claim 13, wherein the transmission weight is a transmission weight selected from among a plurality of transmission weights obtained from the second base station device.
